(19) United States
(12) Patent Application Publication
(10) Pub. No.: US 2005/0022241 A1
(43) Pub. Date: Jan. 27, 2005

(54) Adaptable programming guide for networked devices

(76) Inventor: Theodore L. Griggs, Woodside, CA (US)

Correspondence Address: Thomas B. Haverstock;HAVERSTOCK & OWENS LLP, 162 North Wolfe Road, Sunnyvale, CA, 94086, US

(21) Appl. No.: 10/846,096

(22) Filed: May 14, 2004

Related U.S. Application Data
(63) Continuation-in-part of application No. 10/000,495, filed on Oct. 30, 2001.
Application No. 10/000,495 is a continuation-in-part of application No. 09/909,676, filed on Jul. 19, 2001.
(60) Provisional application No. 60/470,748, filed on May 14, 2003.
(60) Provisional application No. 60/244,790, filed on Oct. 31, 2000.

(51) Int. Cl. H04N 7/16; G06F 13/00; H04N 5/445

(52) U.S. Cl. 725/48; 725/39

(57) ABSTRACT

An electronic content guide is disclosed. The electronic content guide preferably includes a source field for listing content sources and output devices. The electronic content guide also includes a first content field for listing schedule data corresponding to first content data presently available for viewing from each one of the content sources and for listing display information corresponding to the first content data being displayed for viewing at a present time by each one of the output devices. Preferably, the source field and the first content field are displayable in parallel columns. The electronic content guide can also include a second content field, displayable in a column parallel to the source field and the first content field, corresponding to a second content data. In one embodiment, the first content data from each content source can be displayed simultaneously on more than one of the output devices.

### RELATED APPLICATION(S)

This Patent Application claims priority under 35 U.S.C. 119 (e) of the co-pending U.S. Provisional Patent Application, Ser. No. 60/470,748, filed May 14, 2003, and entitled “ADAPTABLE PROGRAMMING GUIDE FOR NETWORKED DEVICES”. The Provisional Patent Application, Ser. No. 60/470,748, filed May 14, 2003, and entitled “ADAPTABLE PROGRAMMING GUIDE FOR NETWORKED DEVICES” is also hereby incorporated by reference. This Patent Application is also a continuation-in-part of the co-pending U.S. patent application Ser. No. 10/000,495, and entitled “ADAPTABLE PROGRAMMING GUIDE FOR NETWORKED DEVICES, filed Oct. 30, 2001. The application Ser. No. 10/000,495, and entitled “ADAPTABLE PROGRAMMING GUIDE FOR NETWORKED DEVICES, filed Oct. 30, 2001 is hereby incorporated by reference. Also, the application Ser. No. 10/000,495, and entitled “ADAPTABLE PROGRAMMING GUIDE FOR NETWORKED DEVICES, filed Oct. 30, 2001 is a continuation-in-part of co-pending application Ser. No. 09/909,676, filed Jul. 19, 2001, and entitled “MECHANISM FOR DISTRIBUTING CONTENT DATA”. The application Ser. No. 09/909,676, filed Jul. 19, 2001, and entitled “MECHANISM FOR DISTRIBUTING CONTENT DATA”is hereby incorporated by reference and which in turn claims priority under 35 U.S.C. 119 (e) of the co-pending U.S. Provisional Patent Application, Ser. No. 60/244,790, filed Oct. 31, 2000, and entitled “ADAPTABLE PROGRAMMING GUIDE FOR NETWORK DEVICES”. The Provisional Patent Application, Ser. No. 60/244,790, filed Oct. 31, 2000, and entitled “ADAPTABLE PROGRAMMING GUIDE FOR NETWORK DEVICES” is also hereby incorporated by reference.

### FIELD OF THE INVENTION

The present invention relates to systems for and methods of distributing content data. More specifically, this invention relates to an apparatus and method of formatting an on-screen programming guide that is adaptable to both a variety of content sources and output devices.

### BACKGROUND OF THE INVENTION

There are numerous media services which provide scheduled programs on a viewing device, such as a televison set. There are standard broadcast services which provide channels that can be received by virtually any television tuner through an antenna connector. There are cable services which typically offer packages of preselected channels to the consumers and that required a decoder at the televison tuner or on the cable line at an external location. Cable services continuously broadcast scheduled programing through a preselected set of channels which are received through a cable connector on a televison set. There are also a number of pay-per-view services which allow costumers to receive scheduled one time program transmissions through the cable network. Other available services include satellite programming which allow consumers to select on demand pay-per view-programs from a set of available programs.

With the ever increasing number of available TV channels available, the viewer has a wide range of programs to select among. Selection is time consuming and planning ones TV consumption has become a challenge. Channel surfing is no longer fast enough to allow getting an overview of all channels. Daily newspapers and other paper publications have long provided channel listings, often using a grid format that shows what programs are on what channel at what time. However, the amount of TV programs typically exceed the limits of what can reasonably be printed. Further, a newspaper or other publication is not always available to the viewer when the viewer decides to watch television. Attempting to meet this problem of information overload and changing requirements, set-top boxes with electronic program guides have emerged in the past several years.

Electronic program guides are on-screen guides or programming schedules that provide program listings for channels that are broadcast or provided by a cable system. Prior art electronic program guides offer online searching through program listings and schedules by genre, title or data. When a television viewer uses such a schedule, the viewer can find a program of interest, identify the channel, and punch the number into a remote control device. Similarly, if a viewer, for example, desires to watch football games on television, the user scans the program schedule for such programs.

One such prior art electronic program guide is shown in FIG. 1. The prior art guide 100 includes a list of channels 110, a time schedule 120, a grid display 130 of programs, and a description section 140 for conveying additional text information about the programs. The programs are displayed consecutively for each channel in the form of a grid. The prior art guide 100, however, is deficient for many reasons. The prior art guide 100 typically includes only one source of content, i.e. broadcast television on a predetermined schedule. Thus, the prior art guide 100 does not provide the viewer with the capability of, or comprehensive information about, purchasing or receiving pay-per-view events, on demand programming, streaming media content off the Internet, or content from consumer electronic devices such as DVD players and VCRs. The prior art guide 100 also has a static time range and can only display shows within that time range. As shown in FIG. 1, the time schedule 120 displays two hours of schedule information. In the case of a two-hour movie, the viewer is not provided with any information as to what program is appearing immediately following the two-hour movie. The viewer is also left with the burden of navigating through the guide by scrolling back and forth. In addition, the prior art guide 100 does not provide display information showing where, for example, a selected program is being played. For example, in a modem home entertainment system where the viewer can play a DVD located in the family room on a television located in a bedroom, the prior art guide 100 does not have the capability of visually displaying what content is being displayed by what output device.

What is needed is an electronic programming guide that is adaptable to various sources of content such as scheduled-based broadcast content, digitally stream-able on-demand multimedia content, and controllable consumer electronic devices. What is also needed is a programming guide that includes both the sources of content available to a user as well as any output device or devices for displaying the content sources.

### SUMMARY OF THE INVENTION

The present invention teaches an innovative format for an electronic programming guide that is adaptable to various sources of content such as scheduled-based broadcast content, digitally stream-able on-demand multimedia content, and controllable consumer electronic devices. The programming guide of the present invention can include both the sources of content available to a user as well as any output device or devices for displaying the content sources.

In accordance with one embodiment of the present invention, an electronic content guide is disclosed. The electronic content guide comprises a source field for listing content sources and output devices; and a first content field for listing schedule data corresponding to first content data presently available for viewing from each one of the content sources and for listing display information corresponding to the first content data being displayed for viewing at a present time by each one of the output devices.

Preferably, the source field and the first content field are displayable in parallel columns. The content sources can include at least one of: scheduled broadcast content; non-scheduled broadcast content; and consumer source devices. The scheduled broadcast content can include at least one of: a network station, a cable channel, a satellite-based channel, and a pay-per-view channel. The non-scheduled content can include at least one of: on-demand programming, streaming media content, and downloadable multimedia files. The consumer source devices can include at least one of: a DVD player, a television tuner, a VCR, a PVR, an MP3 player, a digital video recorder, a PDA, a cellular telephone, and a computer.

Preferably, the first content data corresponding to the scheduled broadcast content comprise a program title and a corresponding program time. Preferably, the first content data corresponding to the non-scheduled content comprise a program title and a source identifier. Preferably, the first content data corresponding to the consumer source device comprise a program title and a status identifier. Preferably, the first content data corresponding to the output devices comprise a program title and a status identifier. Alternatively, the first content data corresponding to the output devices comprise an output device location corresponding to a program title and a status identifier. The output devices can include at least one of: a stereo speaker, a computer monitor, a computer speaker, a display device; and a storage device.

The electronic content guide can further include a second content field, displayable in a column parallel to the source field and the first content field, corresponding to a second content data. Preferably, the second content data corresponding to the scheduled broadcast content can comprise a program title that is immediately available for viewing from the content sources after completion of the presently available first content data, wherein the program title includes a corresponding program time. Preferably, the second content data corresponding to the non-scheduled content comprise a download time and a download fee. Preferably, the second content data corresponding to the consumer source devices comprise a physical location of the consumer source devices. Preferably, the second content data corresponding to the output devices comprise a physical location of the output devices where the first content data are being displayed. The electronic content guide can further include a descriptor field for displaying a detailed description of each content source, each output device, the first content data, and the second content data.

In accordance with another embodiment of the present invention, an electronic content guide is disclosed. The electronic content guide includes a source field for listing content sources and output devices. The electronic content guide also includes a first content field for listing schedule data corresponding to first content data presently available for viewing from the content sources and for listing display information corresponding to the first content data being displayed for viewing at a present time by the output devices. The electronic content guide further includes a second content field for listing schedule data corresponding to second content data that are immediately available for viewing from the content sources after completion of the presently available first content data and for listing locations of the output devices where the first content data are being displayed. Preferably, the source field, the first content field and the second content field are displayable in parallel columns. The electronic content guide can also include a descriptor field for displaying a detailed description of each content source, each output device, the first content data, and the second content data.

In accordance with another embodiment of the present invention, an electronic content guide is disclosed. The electronic content guide includes a source field for listing content sources and output devices; and a first content field for listing schedule data corresponding to first content data presently available for viewing from the content sources and for listing display information corresponding to the first content data being displayed for viewing at a present time by each one of the output devices; wherein the first content data from each content source can be displayed simultaneously on more than one of the output devices. The electronic content guide can also include a second content field, displayable in a column parallel to the source field and the first content field, corresponding to a second content data. The electronic content guide can also include a descriptor field for displaying a detailed description of each content source, each output device, the first content data, and the second content data.

### BRIEF DESCRIPTION OF THE DRAWINGS

FIG. 1 shows a prior art on-screen programming guide for listing content providers and corresponding program availabilities.

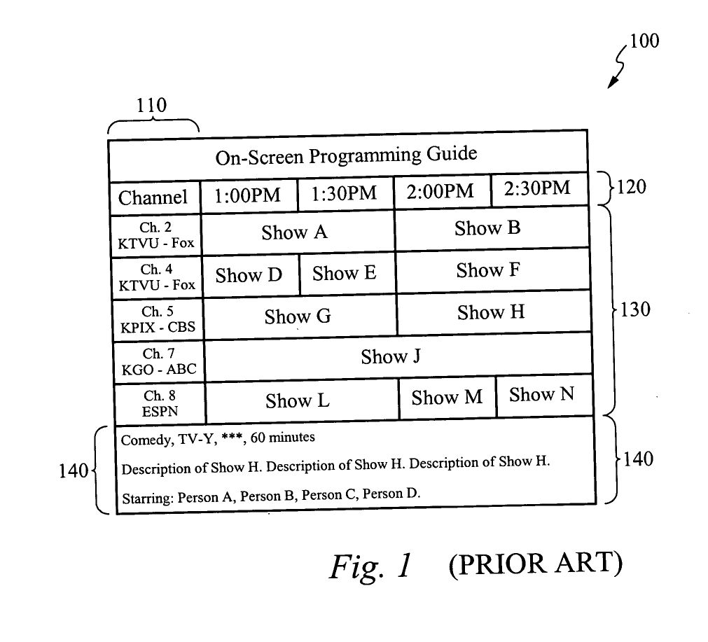

FIG. 2 shows an on-screen programming guide adaptable for listing multiple source providers, including source listings, content listings and availabilities, and output devices for displaying the media content, in accordance with the present invention.

### DETAILED DESCRIPTION OF A PREFERRED EMBODIMENT

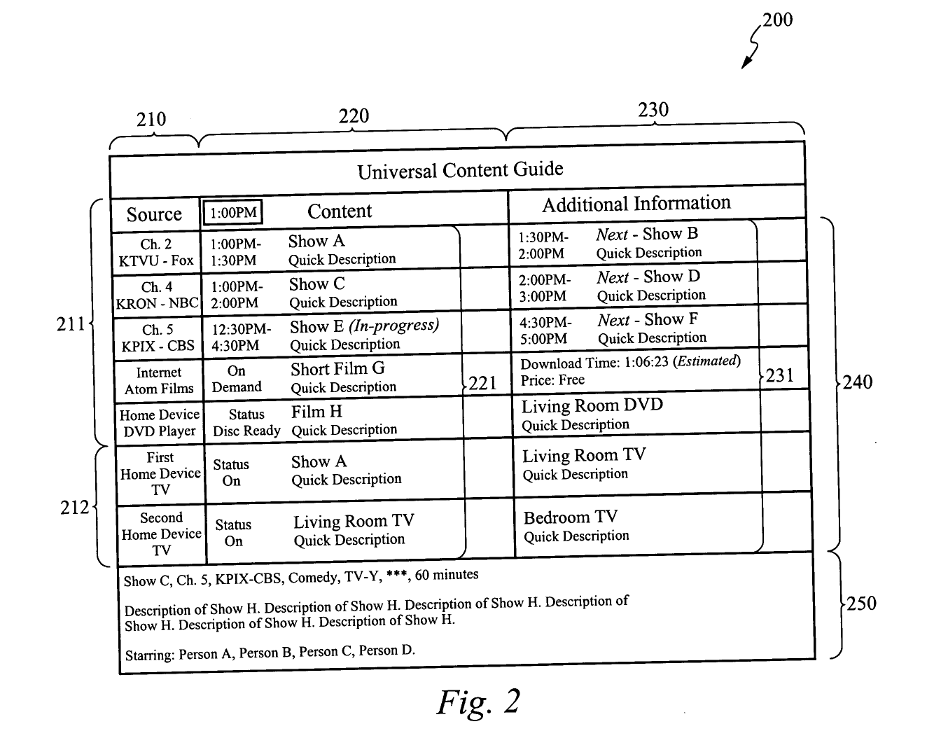

FIG. 2 shows an on-screen programming guide adaptable for listing multiple source providers, including source listings, content listings and availabilities, and output devices for displaying the media content, in accordance with one embodiment of the present invention. The guide 200 lists any number of content sources 211 and output devices 212 within a source field 210. The guide 200 also includes a first content field 220 for listing schedule data corresponding to first content data 221 presently available for viewing from the content sources 211 and for listing display information corresponding to the first content data 221 being displayed for viewing at a present time by the output devices 212. The guide 200 can further include a second content field 230 for listing schedule data corresponding to second content data 231 that are immediately available for viewing from the content sources 211 after completion of the presently available first content data 221 and for listing locations of the output devices 212 where the first content data 221 are being displayed. The second content field 230 can also include download and pricing information, if applicable, for the content sources 221. The second content field can even include source location information, if applicable, for the content sources 221. Preferably, the source field 210, the first content field 220 and the second content field 230 are all displayable in parallel columns with each other using a grid format 240. The guide 200 can also include a descriptor field 250 for displaying a detailed description of each content source 211, each output device 212, the first content data 221 and the second content data 231.

The content sources 211 within the source field 210 can comprise scheduled broadcast content, non-scheduled content, and consumer source devices. The scheduled broadcast content can include at least one of: a network station, a cable channel, a satellite-based channel, and a pay-per-view channel. The non-scheduled content can include at least one of: on-demand programming, streaming media content, and downloadable multimedia files. The consumer source devices can include at least one of: a DVD player, a VCR, a PVR, an MP3 Player, a digital video recorder, a television tuner a PDA, a cellular telephone, and a computer. For example, the content sources 211 within the source field 210 comprise the network stations Ch. 2 KTVU-FOX, Ch. 4 KRON-NBC, Ch. 5 KPIX-CBS; the downloadable file from the Internet (Atom Films); and the consumer source device Home Device DVD player. It will be apparent that additional content sources can be included within the source field 210.

The output devices 212 within the source field 210 can comprise at least one of: a television, a stereo speaker, a computer monitor, a computer speaker, a display device, and a storage device. For example, the output devices 212 within the source field 210 comprise two Home Device Televisions. In one embodiment, the televisions display content from any one of the content sources 211.

In accordance with one embodiment of the present invention, the first content data 221 corresponding to the scheduled broadcast content comprise a program title and a corresponding program time. For example, within the first content field 220 an entry for Show A is listed as being available from Ch. 2 KTVU-FOX. The Show A has a start time of 1:00 PM and a finish time of 1:30 PM. Also, within the first content field 220 an entry for Show C is listed as being available from Ch. 4 KRON-NBC. The Show C has a start time of 1:00 PM and a finish time of 2:00 PM. Further, within the first content field 220 an entry for Show E is listed as being available from Ch. 5 KPIX-CBS. The Show E has a start time of 12:30 PM and a finish time of 4:30 PM.

In accordance with one embodiment of the present invention, the first content data 221 corresponding to the non-scheduled content comprise a program title and a source identifier. For example, within the first content field 220 an entry for Short Film G is listed as being available from the Internet. The Short Film G is an On-Demand program with no program start time.

In accordance with one embodiment of the present invention, the first content data 221 corresponding to the consumer source devices comprise a program title and a status identifier. For example, within the first content field 220 an entry for Film H is listed as being available from the Home Device DVD Player. In this example, the Film H is recorded on a DVD. As mentioned above, the consumer source device listed on the guide 200 can be any consumer source device, such as a VCR, PVR an MP3 player, television tuner, a digital video recorder, a PDA, a cellular telephone or computer, that displays its content on an output device such as a television.

In accordance with one embodiment of the present invention, the first content data 221 corresponding to the output devices comprise a program title and a status identifier. For example, within the first content field 220 an entry for Show A is listed as being sent to and displayed by a first Home Device television. The entry for Show A also lists the first television as being “on” next to “Status”. Thus, the guide 200 lists Show A as being displayed on the first television, which is “on”. Also, within the first content field 220 an entry for Living Room TV is listed as being available from a second Home Device television. However, as will be explained more fully below in connection with the second content field 230, the Living Room TV is actually the first television and the second television is a Bedroom TV. In this example, as the guide 200 shows, the Living Room TV is watching the Show A, and the Bedroom TV is watching what the Living Room TV is watching. Thus, Show A is being displayed on both the first television (Living Room TV) and the second television (Bedroom TV).

In accordance with another embodiment of the present invention and as mentioned above, the second content field 230, which is displayable in a column parallel to the source field 210 and the first content field 220, corresponds to the second content data 231. In one embodiment, the second content data 231 corresponding to the scheduled broadcast content comprise a program title that is immediately available for viewing from the content sources 211 after completion of the presently available first content data 221. The program title of the scheduled broadcast content includes a corresponding program time. For example, within second content field 230 a Show B is listed as being available from the Ch.2 KTVU-FOX immediately following completion of the Show A. The Show B has a start time of 1:30 PM and a finish time of 2:00 PM. Also, within the second content field 230 a Show D is listed as being available from the Ch. 4 KRON-NBC immediately following completion of the Show C. The Show D has a start time of 2:00 PM and a finish time of 3:00 PM. Further, within the second content field 230 a Show F is listed as being available from the Ch.5 KPIX-CBS immediately following completion of the Show E. The Show F has a start time of 4:30 PM and a finish time of 5:00 PM. Unlike the grid format of the prior art guide 100 which has a static time range and can only display programs within that time range, the guide 200 of the present invention shows what program is next available following the completion of the presently available program no matter what time the next program comes on. In the FIG. 2, this is shown on the rows whose sources are Ch.2 KTVU-FOX, Ch. 4 KRON-NBC, and Ch.5 KPIX-CBS.

In one embodiment of the present invention, the second content data 231 corresponding to the non-scheduled content comprise a download time and a download fee, if applicable. For example, the Short Film G listed in the first content field 220 has a download time of 1:06:23 (estimated) and no download fee, which are listed in the second content field 230.

In one embodiment of the present invention, the second content data 231 corresponding to the consumer source devices comprise a physical location of the consumer source devices. For example, the Home Device DVD Player listed under the source field 210 is physically located in the Living Room under the second content field 230. Thus, a viewer using the guide 200 can realize that the Home Device DVD Player, which contains the DVD Film H, is actually the DVD Player located in the living room.

In one embodiment of the present invention, the second content data corresponding to the output devices comprise a physical location of the output devices where the first content data are being displayed. For example, within the second content field 230 an entry for Living Room TV and Bedroom TV are listed on the rows whose sources are First Home Device TV and Second Home Device TV, respectively. The First Home Device TV is actually the television located in the living room. Similarly, the Second Home Device TV is actually the television located in the bedroom. As shown on the guide 200, the Living Room TV is presently playing Show A while the Bedroom TV is playing what the Living Room TV is playing, i.e. the Show A.

In another embodiment of the present invention, the first content data 221 from each content source 211 can be displayed simultaneously on more than one of the output devices 212. This novel feature of the present invention allows, for example, two viewers, one located in the living room the other in the bedroom, to simultaneously view the same on-demand program listed in the first content field 220. This feature is especially useful in home entertainment systems with multiple source devices and output devices all interconnected with one another.

In another embodiment of the present invention and still referring to FIG. 2, the guide 200 can include a descriptor field 250 for displaying a detailed description of each content source 211, each output device 212, the first content data 221, and the second content data 231. The descriptor field preferably comprises an area for listing more detailed information about each selected item. For example, the descriptor field 250 can include a detailed description of a television program selected and/or status information of an output device.

The electronic program guide of the present invention can be supported with any number of network architectures, hardware and software. Therefore, the present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications can be made in the embodiment chosen for illustration without departing from the spirit and scope of the invention.

1. An electronic content guide comprising:
a. a source field for listing content sources and output devices; and
b. a first content field for listing schedule data corresponding to first content data presently available for viewing from each one of the content sources and for listing display information corresponding to the first content data being displayed for viewing at a present time by each one of the output devices.

2. The electronic content guide of claim 1 wherein the source field and the first content field are displayable in parallel columns.

3. The electronic content guide of claim 2 wherein the content sources comprise scheduled broadcast content, including at least one of: a network station, a cable channel, a satellite-based channel, and a pay-per-view channel.

4. The electronic content guide of claim 3 wherein the first content data corresponding to the scheduled broadcast content comprise a program title and a corresponding program time.

5. The electronic content guide of claim 4 wherein the content sources further comprise non-scheduled content including at least one of: on-demand programming, streaming media content, and downloadable multimedia files.

6. The electronic content guide of claim 5 wherein the first content data corresponding to the non-scheduled content comprise a program title and a source identifier.

7. The electronic content guide of claim 6 wherein the content sources further comprise consumer source devices including at least one of: a DVD player, a VCR, a PVR, an MP3 player, a digital video recorder, a PDA, a cellular telephone, and a computer.

8. The electronic content guide of claim 7 wherein the first content data corresponding to the consumer source devices comprise a program title and a status identifier.

9. The electronic content guide of claim 8 wherein the output devices comprise at least one of: a television, a stereo speaker, a computer monitor, a computer speaker, a display device, and a storage device.

10. The electronic content guide of claim 9 wherein the first content data corresponding to the output devices comprise a program title and a status identifier.

11. The electronic content guide of claim 9 wherein the first content data corresponding to the output devices comprise an output device location corresponding to a program title and a status identifier.

12. The electronic content guide of claim 10 further comprising a second content field, displayable in a column parallel to the source field and the first content field, corresponding to a second content data.

13. The electronic content guide of claim 12 wherein the second content data corresponding to the scheduled broadcast content comprise a program title that is immediately available for viewing from the content sources after completion of the presently available first content data, the program title including a corresponding program time.

14. The electronic content guide of claim 13 wherein the second content data corresponding to the non-scheduled content comprise a download time and a download fee.

15. The electronic content guide of claim 14 wherein the second content data corresponding to the consumer source devices comprise a physical location of the consumer source devices.

16. The electronic content guide of claim 15 wherein the second content data corresponding to the output devices comprise a physical location of the output devices where the first content data are being displayed.

17. The electronic content guide of claim 16 further comprising a descriptor field for displaying a detailed description of each content source, each output device, the first content data, and the second content data.

18. An electronic content guide comprising:
a. a source field for listing content sources and output devices; and
b. a first content field for listing schedule data corresponding to first content data presently available for viewing from the content sources and for listing display information corresponding to the first content data being displayed for viewing at a present time by the output devices; and
c. a second content field for listing schedule data corresponding to second content data that are immediately available for viewing from the content sources after completion of the presently available first content data and for listing locations of the output devices where the first content data are being displayed.

19. The electronic content guide of claim 18 wherein the source field, the first content field and the second content field are displayable in parallel columns.

20. The electronic content guide of claim 19 wherein the content sources comprise scheduled broadcast content, including at least one of: a network station, a cable channel, a satellite-based channel, and a pay-per-view channel.

21. The electronic content guide of claim 20 wherein the first content data corresponding to the scheduled broadcast content comprise a program title and a corresponding program time.

22. The electronic content guide of claim 21 wherein the content sources further comprise non-scheduled content including at least one of: on-demand programming, streaming media content, and downloadable multimedia files.

23. The electronic content guide of claim 22 wherein the first content data corresponding to the non-scheduled content comprise a program title and a source identifier.

24. The electronic content guide of claim 23 wherein the content sources further comprise consumer source devices including at least one of: a DVD player, a VCR, a PVR, an MP3 player, a digital video recorder, a PDA, a cellular telephone, and a computer.

25. The electronic content guide of claim 24 wherein the first content data corresponding to the consumer source device comprises a program title and a status identifier.

26. The electronic content guide of claim 25 wherein the output devices comprise at least one of: a television, a stereo speaker, a computer monitor, a computer speaker, a display device, and a storage device.

27. The electronic content guide of claim 26 wherein the first content data corresponding to the output devices comprise a program title and a status identifier.

28. The electronic content guide of claim 26 wherein the first content data corresponding to the output devices comprise an output device location corresponding to a program title and a status identifier.

29. The electronic content guide of claim 27 wherein the second content data corresponding to the scheduled broadcast content comprise a program title and a corresponding program time.

30. The electronic content guide of claim 29 wherein the second content data corresponding to the non-scheduled content comprise a download time and a download fee.

31. The electronic content guide of claim 30 wherein the second content data corresponding to the consumer devices comprise a physical location of the consumer source devices.

32. The electronic content guide of claim 31 wherein the second content data corresponding to the output devices comprise a physical location of the output devices where the first content data are being displayed.

33. The electronic content guide of claim 32 further comprising a descriptor field for displaying a detailed description of each content source, each output device, the first content data, and the second content data.

34. An electronic content guide comprising:
a. a source field for listing content sources and output devices; and
b. a first content field for listing schedule data corresponding to first content data presently available for viewing from the content sources and for listing display information corresponding to the first content data being displayed for viewing at a present time by each one of the output devices; wherein the first content data from each content source can be displayed simultaneously on more than one of the output devices.

35. The electronic content guide of claim 34 wherein the source field and the first content field are displayable in parallel columns.

36. The electronic content guide of claim 35 wherein the content sources comprise scheduled broadcast content, including at least one of: a network station, a cable channel, a satellite-based channel, and a pay-per-view channel.

37. The electronic content guide of claim 36 wherein the first content data corresponding to the scheduled broadcast content comprise a program title and a corresponding program time.

38. The electronic content guide of claim 37 wherein the content sources further comprise non-scheduled content including at least one of: on-demand programming, streaming media content, and downloadable multimedia files.

39. The electronic content guide of claim 38 wherein the first content data corresponding to the non-scheduled content comprises a program title and a source identifier.

40. The electronic content guide of claim 39 wherein the content sources further comprise consumer source devices including at least one of: a DVD player, a VCR, a PVR, an MP3 player, a digital video recorder, a PDA, a cellular telephone, and a computer.

41. The electronic content guide of claim 40 wherein the first content data corresponding to the consumer source devices comprise a program title and a status identifier.

42. The electronic content guide of claim 41 wherein the output devices comprise at least one of: a television, a stereo speaker, a computer monitor, a computer speaker, a display device, and a storage device.

43. The electronic content guide of claim 42 wherein the first content data corresponding to the output devices comprise a program title and a status identifier.

44. The electronic content guide of claim 42 wherein the first content data corresponding to the output devices comprise an output device location corresponding to a program title and a status identifier.

45. The electronic content guide of claim 43 further comprising a second content field, displayable in a column parallel to the source field and the first content field, corresponding to a second content data.

46. The electronic content guide of claim 45 wherein the second content data corresponding to the scheduled broadcast content comprise a program title that is immediately available for viewing from the content sources after completion of the presently available first content data, the program title including a corresponding program time.

47. The electronic content guide of claim 46 wherein the second content data corresponding to the non-scheduled content comprise a download time and a download fee.

48. The electronic content guide of claim 47 wherein the second content data corresponding to the consumer source devices comprise a physical location of the consumer source devices.

49. The electronic content guide of claim 48 wherein the second content data corresponding to the output devices comprise a physical location of the output devices where the first content data are being displayed.

50. The electronic content guide of claim 49 further comprising a descriptor field for displaying a detailed description of each content source, each output device, the first content data, and the second content data.
